(19) United States
(12) Patent Application Publication
(10) Pub. No.: US 2016/0008112 A1
(43) Pub. Date: Jan. 14, 2016

(54) Method for Producing a Distortion-Free Dental Model, and Dental Model so Produced

(71) Applicant: EOS GMBH ELECTRO OPTICAL SYSTEMS, Krailling (DE)

(72) Inventors: Gregor Reischle, Munchen (DE); Sabine Hein, Munchen (DE)

(73) Assignee: EOS GMBH ELECTRO OPTICAL SYSTEMS, Krailling OT (DE)

(21) Appl. No.: 14/770,967

(22) PCT Filed: Mar. 10, 2014
(86) PCT No.: PCT/EP2014/054603

§ 371 Date: Aug. 27, 2015

(30) Foreign Application Priority Data
Mar. 11, 2013 (DE) 10 2013 204 146.2

(51) Int. Cl. A61C 13/34; A61C 13/00

(52) U.S. Cl. CPC A61C 13/34; A61C 13/0004; B33Y 10/00

(57) ABSTRACT

A method for producing a dental model by means of a generative layering technique comprises the following steps: altering a three-dimensional CAD model of the dental model, wherein gap-like recesses are generated, such that the CAD model is cut into segments by the gap-like recesses, and connecting bridges are placed in the CAD model in such a way that the connecting bridges connect adjacent segments to each other, producing the dental model by means of a generative layering technique on the basis of the altered three-dimensional CAD model.

The present invention is directed to a method for manufacturing parts by means of a generative manufacturing method in a warpage-free way and to the parts obtained thereby and specifically to a dental model.

The term “dental model” is understood by the present application as a three-dimensional 1:1 reproduction of a jawbone surrounded by gingiva, where there may also be a tooth or tooth stump in the jawbone. When the method is applied for manufacturing full dentures, there is no tooth or tooth stump in the dental model.

The known conventional manufacturing method includes many steps performed manually as a result of the high demands on accuracy such as when manufacturing a crown or a bridge.

One of the steps that are performed manually is the manufacture of a dental model by casting plaster into a mold. The hardened plaster then results in the dental model.

Another one of these manual steps effects a sawing through of the dental model at predetermined positions between the teeth. This is necessary for making possible a lateral access to the corresponding positions in the dental model, which on the other hand is a precondition for being able to model the denture in an exact way.

Before the dental model is worked on, it is necessary to establish reference points between the dental model and a so-called mounting plate.

When working on the dental model it is important to restore the original position and orientation of the individual segments or single teeth in the dental model after having executed working steps at the individual segments or single teeth.

In order to do so, a so-called mounting plate is used, which mounting plate has reference connections with the dental model and the individual segments or single teeth, respectively.

This makes it possible for the dental technician to remove the individual segments or single teeth from the mounting plate, to work on them and to put them into place again without a change of the original position and orientation of the segments or single teeth in the dental model.

Several alternative mounting plates are known. A first alternative is a prefabricated standard mounting plate with pins that are arranged with a fixed pitch. A second type of mounting plate is individually manufactured.

A dental model that is used together with the standard mounting plate needs holes at its bottom side that have the same pitch as the pins on the mounting plate.

This has the disadvantage that exactly at that position at which the dental model is cut through a hole may be present and the corresponding pin will fail to encounter a hole so that a reference connection is “destroyed”. In particular, when a single tooth is arranged in the dental model, it may happen that each of the cuts that are present at both sides of the single tooth encounters a hole, so that several reference connections are “destroyed”. This disadvantageously leads to a single tooth having a position that is no longer well-defined.

The second alternative for a mounting plate is individually manufactured for each dental model. A dental model that works together with this type of mounting plate also needs holes at its bottom side. However, these holes are not tied to a predefined pitch, but may be individually arranged for each dental model.

In order to define the reference connections between the dental model and a mounting plate according to the second alternative for the first time, the procedure is as follows:

Pins are inserted into the holes that are present at the bottom side of the dental model, such pins having a length dimensioned such that after having been inserted into the holes they still protrude by a certain amount from the dental model.

Preferably, sheaths are attached to the protruding part of the pins. The sheaths at their inner surfaces preferably consist of a low-friction material.

Subsequently, those parts of the pins that protrude from the dental model, which parts are surrounded by sheaths, are pressed into a bed of plaster. Preferably, the sheaths may have structured outsides, which structured outsides lead to a form-lock between the sheaths and the mounting plate after the hardening of the plaster.

After the hardening of the plaster the dental model can be removed from the mounting plate. Here, the sheath remains in the mounting plate and the pins remain in the dental model, wherein it is not relevant for the functioning of the pins as reference connection, whether they remain in the dental part or in the mounting plate.

For this alternative of the mounting plate it is possible to arrange the holes in the dental model such that they are not located at a position at which the dental model is cut through later on. Thereby it is possible to provide many reference connections also for single teeth.

Now the dental model is cut at the designated positions and the individual segments or single teeth result therefrom.

Subsequently, these segments or single teeth are connected again to the mounting plate by means of the reference connections. As a result a dental model is obtained, in which the individual segments or teeth are again accurately positioned with the correct orientation with respect to the other portions of the dental model. The material loss that occurred during the sawing process becomes visible as gap, however, has no negative effect on the correct orientation of the portions with respect to each other.

The individual segments or single teeth may be removed from the mounting plate for further processing steps—for example for processing them manually—and may be re-attached to the mounting plate afterwards. The correct orientation of the portions with respect to one another is always preserved.

By means of additive manufacturing methods it is possible to manufacture dental models that act together with mounting plates of either the first type or the second type described above.

However, it appeared that a warpage of the dental model may occur when manufacturing the dental model by means of an additive manufacturing method. The larger the dental model the greater the danger that a warpage occurs.

A method is known to the applicant in which a dental model is changed by means of a CAD Program such that a gap is created at those positions at which the material is usually cut through by means of a saw, wherein the gap corresponds to the material loss resulting from the sawing process. Thereby the dental model is split into individual segments or single teeth by means of the CAD program. This has the advantage that the dental model is divided into smaller pieces, which basically reduces the danger of warpage. On the other hand it is disadvantageous in such a case that after the additive manufacturing process the individual portions of the dental model exist disconnectedly.

A dental model manufactured in such a way is not suitable for being used together with a mounting plate according to the second alternative.

The remaining use together with a mounting plate according to the first alternative, however, is again affected by the positions of the cuts in the region of the holes, whereby, as explained above, reference connections may be “destroyed”.

In view of the above-described problems it is an object of the present invention to provide a method that makes it possible to manufacture complete dental models by means of a layer-wise additive manufacturing method, wherein the danger of warpage is minimized and the dental model is suitable for an interaction with a mounting plate according to the second alternative.

This object is achieved by a method according to claim 1 and a dental model according to claim 9. Further developments of the invention are given in the dependent claims.

According to the inventive concept a dental model is manufactured in single segments or single teeth, which are connected to each other and fixed in their positional arrangement with respect to each other by means of connection bridges that have been preferably manufactured by a layer-wise additive manufacturing. By providing gaps separating the individual object segments from each other (except a connection via thin connection bridges) warpage can be remarkably reduced, so that the part dimensions differ from the desired dimensions to a lesser extent.

Amongst other things, by the method according to the invention it is advantageously made possible to remove the dental model as a whole from the powder bed, whereby the process step of sorting the individual parts becomes unnecessary. By providing gap-like recesses between the tooth position in the dental model concomitautly a cutting through at these positions is made easier as only the thin connection bridges have to be cut through.

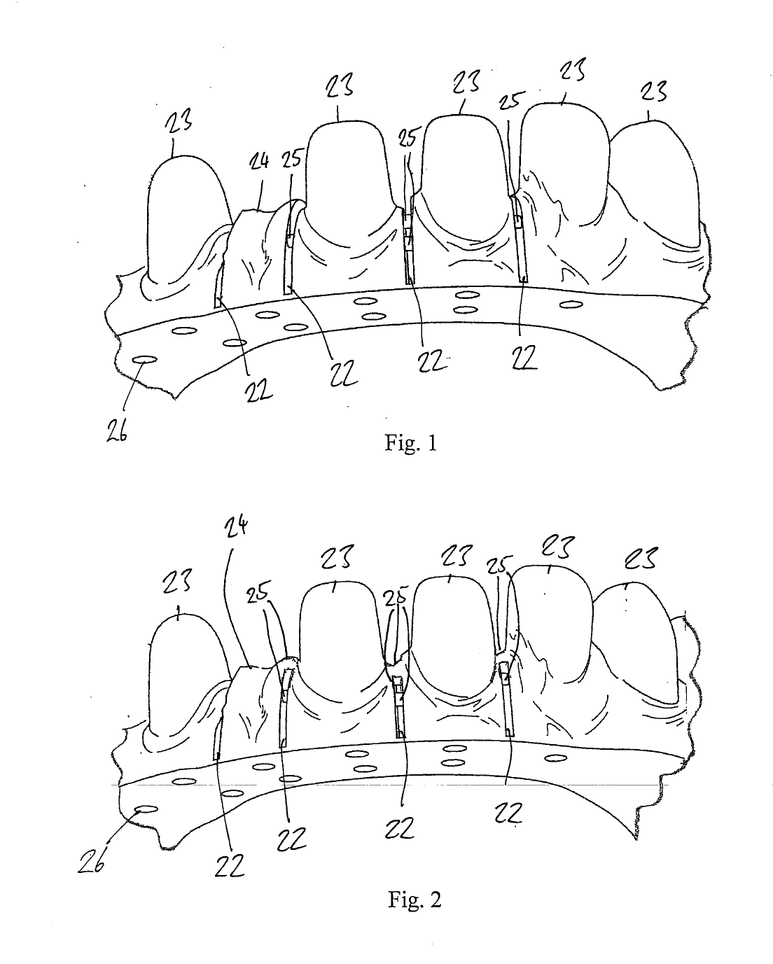

FIG. 1 shows a partial lateral view of a dental model (saw cut model) according to the invention,

FIG. 2 shows a modified embodiment of the dental model shown in FIG. 1,

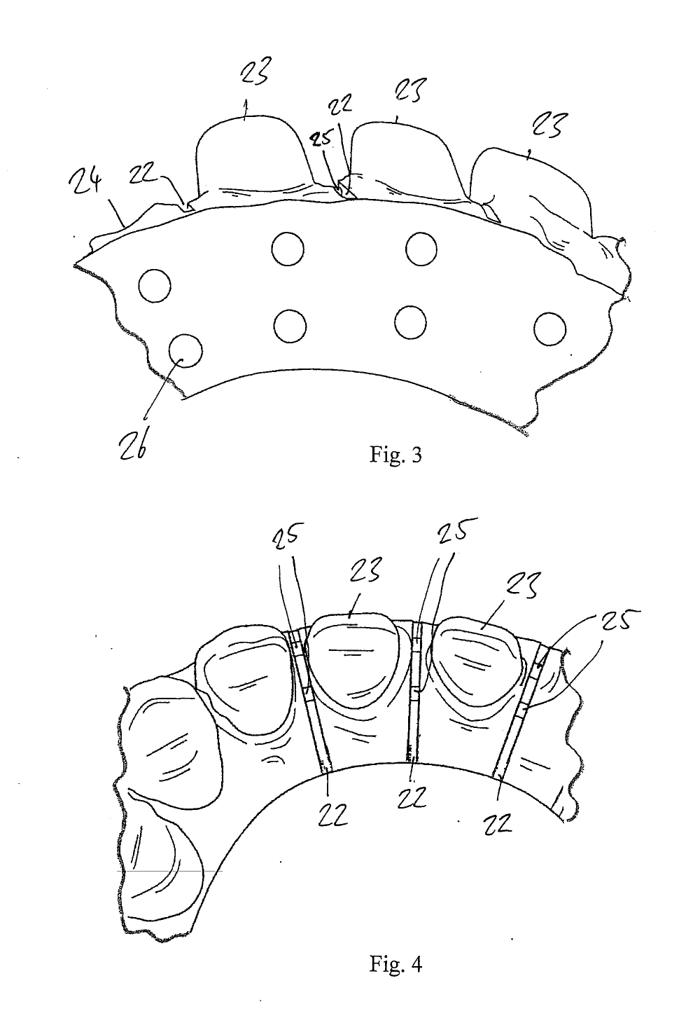

FIG. 3 shows a bottom view of the partial region shown in FIG. 1,

FIG. 4 shows a top view of the partial region shown in FIG. 1, and

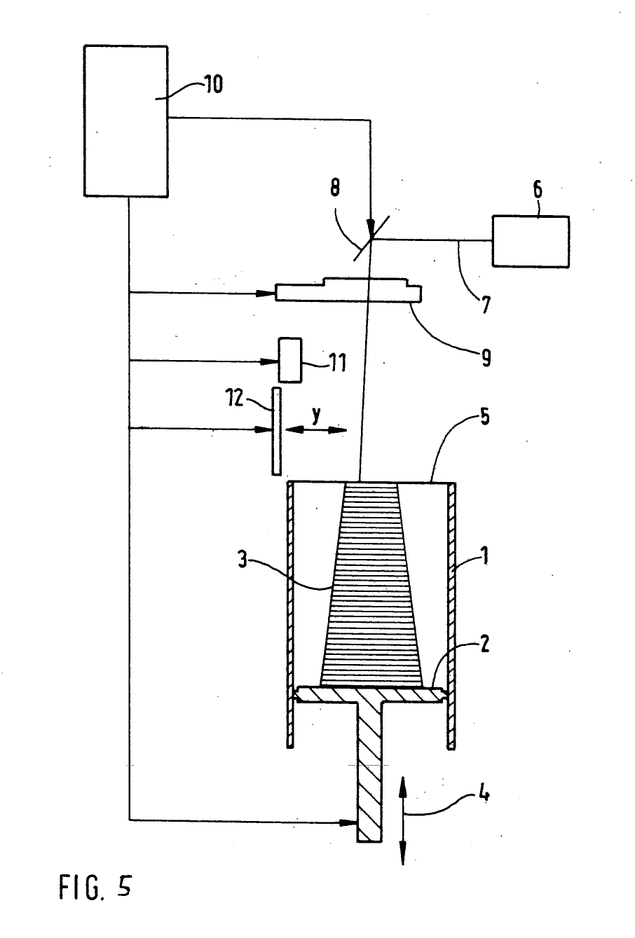

FIG. 5 shows a schematic representation of a laser sintering machine.

For a description of the method according to the invention, in the following a laser sintering method is described as an example with reference to FIG. 5.

The device comprises a construction container 1, in which a support 2 for supporting an object 3 to be formed is provided. By means of a height adjustment device 4 the support 2 can be moved in the construction container in a vertical direction. The plane, in which building material in powder form that has been applied is solidified, defines a working plane 5. A laser 6 is provided for solidifying the material in powder form in the working plane 5. The laser 6 generates a laser beam 7, which is focused onto the working plane 5 by means of a deflection device 8 and, where applicable, a focusing unit 9. A control 10 is provided, which controls the deflection device 8 and, where applicable, the focusing unit 9 such that the laser beam 7 can be directed to any position in the working plane 5. The control 10 is driven by data that comprise the structure of the object to be manufactured (a three-dimensional CAD model of the object). In particular, the data comprise specific information on each layer to be solidified in the manufacture of the object.

Also, a supply device 11 is provided, by which the building material in powder form for a subsequent layer can be supplied. By means of an application device 12 the building material is applied and smoothened in the working plane 5.

In operation, the support 2 is lowered layer by layer, a new powder layer is applied and is solidified by means of the laser beam 7 at those positions of a respective layer in the working plane 5 that correspond to the respective object.

All powders and powder mixtures, respectively, that are suitable for the laser sintering method can be used as building material in powder form. Such powders comprise e.g. plastic powders such as polyamide or polystyrene, PAEK (polyarylene ether ketone), elastomers such as PEBA (polyether block amide), metal powders such as stainless steel powder or other metal powders adapted to the respective purpose, in particular alloys, plastic-coated sand and ceramic powders.

In the following the manufacture of a dental model according to the invention is described.

At first, a CAD model of the jawbone surrounded by gingiva, where there may also be a tooth or tooth stump in the jawbone. When the method is applied for manufacturing full dentures, there is no tooth or tooth stump in the dental model. This surface model of the jaw can be obtained in a non-contact way, e.g. by an oral scan or a CT scan. This CAD model can also be obtained by scanning a dental impression (negative shape) or by scanning a plaster model of the dentition (positive shape).

Then, in this CAD model (the raw data) cuts (gap-like recesses) are added, by which cuts, by which the model is divided into segments. Here, the outer dimensions of the dental model may not change and moreover also the position and orientation of the obtained segments with respect to each other may not be changed.

Now, according to the invention in a further step connection bridges are added at the gap-like recesses, by which connection bridges a partial connection is generated between the segments.

Though in the figures the connection bridges are shown to be inside of the gap-like recesses, it is alternatively possible to provide some or even all connection bridges outside of the gap-like recesses. Thus, connection bridges may be provided at the edge of the gap-like recess such that they protrude to the outside across the edge or else can be provided such that they lie completely outside of a gap-like recess.

Now, the CAD model is divided into layers that correspond to the layers of building material (usually plastic such as polyamide) to be solidified. Then, based on the data resulting therefrom, the manufacture of the model by means of a layer-based additive manufacturing method, preferably a powder-based laser sintering method, is effected. These data are called production data.

Thus, in the example of a laser sintering device described further above the production data would be those data that contain the structure information on the dental model and by which the control 10 is driven. In case the layer-based additive manufacturing method is not a laser sintering method, one can proceed in the same way and the production data, existing in a common format such as the STL format, are processed by a corresponding control 10 also in such a case. In particular, a Fused Deposition Modeling (FDM), a 3D printing as well as a mask sintering method, in each case with a building material in powder form, may be used instead of the laser sintering method. Here, it shall be mentioned that in all methods in which a solidification of the building material in powder form is effected by means of heat, warpage may occur. Even in a 3D printing process, in which a glue is selectively added to the building material, warpage may occur during hardening as usually the glue is applied in different layers at different positions.

In FIGS. 1 to 4 one can recognize in the dental model 1 gap-like recesses 22 between two teeth 23 or else between a tooth 23 and a stump 24 to be prepared. Furthermore, in the gap-like recesses 22 connection bridges 25 are recognizable, which are made by means of the layer-based additive manufacturing method of the same material as the whole rest of the dental model.

As already explained in the introductory part of the description, when preparing dental prostheses, usually the jaw models are provided such that a model mounted on a mounting plate is cut through at several positions, so that single teeth can be removed. If a dental model is used in such a way it will be appropriate to provide the cuts and connection bridges at those positions at which the model will be sawed through later.

Tests were made, in which on the one hand a complete jaw model was manufactured by means of laser sintering and on the other hand a jaw model having the cuts and connection bridges according to the invention was manufactured. It appeared that when proceeding according to the invention, the deviation of the model dimensions from the desired dimensions may be reduced by more than a factor of two. When proceeding according to the invention the deviations may be limited to 30 μm at maximum. Thereby, an accuracy in the manufacturing becomes possible that is similar to the measurement accuracy when carrying out an oral scan.

The less the extent to which the segments are connected to each other, the higher the manufacturing accuracy. For an exact fixation of the orientation of two neighboring segments with respect to each other, preferably at least three connection bridges 25 should be provided. Here, the maximum diameter of each connection bridge 25 (in parallel to the gap-like recess) should lie preferably below 2 mm, particularly preferably below 1 mm. However, it is nevertheless a substantial characteristic of the invention that two neighboring segments are connected to each other in a dimensionally stable way by the connection bridges. In the case of more than three connection bridges 25 between neighboring segments the maximum diameter of the connection bridges can be set to a smaller value than for exactly three connection bridges 25. In the end, for a minimization of warpage the connection bridges should be as thin as possible. However, they should nevertheless have a thickness that provides sufficiently for a dimensional stability of the jaw model.

Though in FIGS. 1 to 3 only a tooth stump 24 is shown as portion to be prepared, it is of course possible to choose a larger portion to be prepared lying between cuts 22, comprising, for example, two or three tooth positions. Thereby, such a portion can for example be used for the manufacture of a bridge. As warpage depends on the size of the segments of the part, there is, however, an upper limit for the size of a segment that lies between two cuts 22. It turned out that the size of a segment should not exceed three tooth positions.

It may be convenient for the dental technician to have cuts (gap-like recesses) 22 between all teeth. Then the dental technician can decide at will, at which positions the jaw model shall be divided.

As shown in FIG. 2, connection bridges can also be positioned at the edges of the gap-like recesses 22 that separate the segments from each other. In FIG. 2, such a bridge is shown in the space between the teeth in a region that has the largest distance to the bottom of the dental model (at the upper edge of the gap-like recess). Here, any variation is possible as long as a fixation of the orientation of the segments to each other is provided for.

Apart from the mounting of the dental model on a premanufactured mounting plate according to the first alternative it is also laboratory practice to use a mounting plate according to the second alternative described in the introductory part of the description. In order to do so, at first single pins are inserted into the holes in the bottom of the dental model, the length of which pins is dimensioned such that they protrude from the dental model. Then the pins protruding from the dental model are pressed into a bed of plaster. In this way, after a hardening of the bed of plaster an accurately fitting mounting plate exists, from which the dental model can be removed again.

When proceeding like this it is of advantage that the holes 26 in the bottom of the dental model can be arranged such that the holes 26 always have a certain distance from the gap-like recesses 22. These holes 26 act together with the pins as reference connection also after the connection bridges 25 have been sawed through.

If the gap-like recesses 22 between the segments at the bottom of the dental model are closed, plaster may be advantageously prevented from entering the gap-like recesses 22. However, such a connection bridge 25 at the bottom for itself will not yet be sufficient for making for a sufficient rigidity of the dental model. As large forces act on the dental model when the dental model is pressed into the bed of plaster, at least one further connection bridge should be additionally assigned to each gap-like recess 22 in order to prevent a twisting of the dental model.

Of course, the connection bridges 25 between the single segments need not necessarily have a pin shape shown in the figures.

For example, it would be possible to form between the segments snap fastener connections instead of the pin-shaped connection bridges 25, which snap fastener connections enable a reversible separation of the segments from each other.

A further design possibility for the connection between the segments is a thin circumferential connection that surrounds the whole gap-like recess 22.

Thus, a gap-like recess 22 would not be recognizable from outside at the completed model. Nevertheless, it would be easily possible to saw through the dental model at the position of the gap-like recess 22, because the circumferential connection has a thickness of only e.g. 500 μm to 1 mm.

Moreover, there is the possibility of forming the connection bridges in the gap-like recess 22 as latticework.

The shape and number of the connection bridges can be freely chosen for given boundary conditions (warpage, stability, etc.). However, as a general rule of thumb one can say that the volume of all connection bridges at a gap-like recess 22 should be smaller than 20% of the volume of the gap-like recess 22.

1. Method for manufacturing a dental model for being applied in dentistry by means of a layer-wise additive manufacturing method, said method including the following steps:
modifying a three-dimensional CAD model of the dental model wherein at least one gap-like recess is generated, so that the CAD model is cut into segments by this at least one gap-like recess,
manufacturing the dental model by means of a layer-wise additive manufacturing method on the basis of the modified three-dimensional CAD model,
characterized in that
in said step of modifying the three-dimensional CAD model at least one connection bridge is generated at at least one of the gap-like recesses, which at least one connection bridge connects the segments abutting said gap-like recess to one another,
wherein said at least one connection bridge is adapted to fix the orientation and position of the segments abutting the gap-like recess with respect to each other.

2. Method according to claim 1, in which at least one connection bridge is generated in a gap-like recess.

3. Method according to claim 1, in which the dental model is a jaw model that corresponds to at least a part of a human jaw and wherein a segment consists of a partial section of the jaw model that comprises one or several teeth.

4. Method according to claim 1, in which the connection bridges are cut through after the manufacture of the dental model.

5. Method according to claim 4, in which reference connections between the dental model and the mounting plate are established before cutting through the connection bridges.

6. Method according to claim 5, in which the reference connections are established such that pins protruding from the mounting plate engage with holes in the bottom of the dental model when the dental model is put onto the mounting plate.

7. Method according to claim 1, in which:
in said step of modifying the three-dimensional CAD model a layer is integrated at the bottom of the CAD model of the dental model as connection bridge in each of the gap-like recesses, which layer connects the segments abutting the gap-like recess with each other,
in said step of modifying the three-dimensional CAD model holes are integrated into the bottom of the CAD model of the dental model,
after the manufacture of said dental model pins are inserted into the holes, wherein the pins protrude by a certain amount from the dental model after having been inserted into the holes,
said pins protruding from said dental model are pressed into a liquid bed of plaster,
after the pressing of the pins it is waited until a mounting plate of plaster has been formed by a solidification of the bed of plaster and
the dental model is removed from the mounting plate, wherein the pins remain either in the dental model or the mounting plate and serve as reference connection between the dental model and the mounting plate.

8. Method according to claim 1, in which between each two neighbouring segments there are provided at least three connection bridges.

9. Method according to claim 1, in which the connection bridges in a gap-like recess are designed such that their total volume is 20% of the volume of the gap-like recess at maximum.

10. Dental model that represents at least a partial section of a human jaw, wherein the dental model has at least one gap-like recess at which at least one connection bridge is arranged that connects both sides of the gap-like recess with each other so that the dental model is cut into two segments by the gap-like recess and the only connection between both segments exists via said at least one connection bridge, wherein said at least one connection bridge is adapted to fix the orientation and position of the segments abutting the gap-like recess with respect to each other
wherein said at least one connection bridge has been made of the same material as the whole rest of the dental model.

11. Dental model according to claim 10, in which between each two neighbouring tooth positions in the jaw a gap-like recess is placed.

12. Dental model according to claim 10, in which at least one connection bridge is positioned in a gap-like recess.

13. Dental model according to claim 12, in which the total volume of said at least one connection bridge in a gap-like recess is 20% of the volume of the gap-like recess at maximum.

14. Dental model according to claim 12, in which in each gap-like recess at least two connection bridges are arranged.

15. Dental model according to claim 12, in which in each gap-like recess a layer exists at the bottom of the dental model.

16. Dental model according to claim 10, in which holes from below exist in the bottom of the dental model corresponding to each tooth position.

17. Dental model according to claim 16, in which by the number and/or arrangement of the holes in the bottom at a tooth position the position of this tooth in the dental model is coded.

18. Dental model according to claim 12, in which a connection bridge in at least one of the gap-like recesses consists of a layer at the edge of the gap-like recess.

19. Dental model according to claim 18, in which the layer captures the whole edge of the gap-like recess.
